(19) United States
(12) Patent Application Publication
(10) Pub. No.: US 2011/0184895 A1
(43) Pub. Date: Jul. 28, 2011

(54) TRAFFIC OBJECT RECOGNITION SYSTEM, METHOD FOR RECOGNIZING A TRAFFIC OBJECT, AND METHOD FOR SETTING UP A TRAFFIC OBJECT RECOGNITION SYSTEM

(76) Inventor: Holger Janssen, Hessisch Oldendorf (DE)

(21) Appl. No.: 12/988,389

(22) PCT Filed: Nov. 19, 2008
(86) PCT No.: PCT/EP08/65793

§ 371 Date: Mar. 25, 2011

(30) Foreign Application Priority Data
Apr. 18, 2008 (DE) 10 2008 001 256.4

(51) Int. Cl. G06F 15/18

(52) U.S. Cl. 706/12

(57) ABSTRACT

A method for setting up a traffic object recognition system. A scene generator simulates three-dimensional simulations of various traffic situations which include at least one of the traffic objects. A projection unit generates signals which correspond to signals that the sensor would detect in a traffic situation simulated by the three-dimensional simulation. The signals are sent to the evaluation unit for recognizing traffic objects, and the pattern recognition is trained based on a deviation between the traffic objects simulated in the three-dimensional simulations of traffic situations and the traffic objects recognized therein.

### FIELD OF THE INVENTION

The present invention relates to a method for setting up a traffic object recognition system, and to a traffic object recognition system, in particular for a motor vehicle, and to a method for recognizing a traffic object.

### BACKGROUND INFORMATION

A training approach for a motor vehicle recognition system for traffic signs is described in the publication “Classifier training based on synthetically generated samples” by Helene Hössler et al., Proceedings of the Fifth International Conference on Computer Vision Systems, published in 2007 by Applied Computer Science Group. Idealized images of traffic signs are provided in the described method. Samples for training the recognition system are generated from these images by using a parametric transformation. The parametric transformation distorts the idealized images to take projection directions, motions, or gray value anomalies into account. The transformations used for geometric shifts, rotations, or other distortions of the signs may be easily determined based on simple geometric principles. Further parametric transformations, which are intended to take into account twilight, raindrops on the windshield, and exposure times of the camera, among other factors, must be checked for suitability. Therefore, uncertainty remains as to whether samples which have been generated on the basis of such transformations are suitable for training a recognition system.

### SUMMARY

An example traffic object recognition system according to the present invention for recognizing one or multiple traffic objects in a traffic situation contains at least one sensor for detecting a traffic situation and a pattern recognition unit for recognizing the one or multiple traffic objects in the detected traffic situation. The pattern recognition unit is trained on the basis of three-dimensional virtual traffic situations which contain the traffic object or objects.

An example method according to the present invention for recognizing one or multiple traffic objects in a traffic situation includes the following steps: detecting a traffic situation with the aid of at least one sensor, and recognizing the one or multiple traffic objects in the detected traffic situation with the aid of a pattern recognition unit which is trained on the basis of three-dimensional virtual traffic situations which contain the traffic object or objects.

An example method according to the present invention for setting up such a traffic object recognition system includes the following method steps: a scene generator simulates three-dimensional simulations of various traffic situations which include at least one of the traffic objects. A projection unit generates signals which correspond to signals that the sensor would detect in a traffic situation simulated by the three-dimensional simulation. The signals are sent to the evaluation unit for recognizing traffic objects, and the pattern recognition unit is trained based on a deviation between the traffic objects simulated in the three-dimensional simulations of traffic situations and the traffic objects recognized therein.

The physical appearance of the traffic objects, the traffic signs, for example, is represented based on the three-dimensional simulations. The position of the traffic objects relative to the sensor in space may be implemented in the simulation in a verifiable manner. All events which may result in an altered perception of the traffic object, for example rain, nonuniform illumination of the signs due to shadows from trees, etc., may be directly simulated using the objects responsible, i.e., the rain and the trees, for example. This simplifies the training of the pattern recognition unit since less time is required.

### BRIEF DESCRIPTION OF THE DRAWINGS

FIG. 1 shows a diagram for explaining a classifier training.

FIG. 2 shows a first specific embodiment for the synthetic training of classifiers.

FIG. 3 shows a second specific embodiment for training classifiers.

FIG. 4 shows a third specific embodiment for training classifiers.

FIG. 5 shows a method sequence for synthesizing digital samples for video-based classifiers.

### DETAILED DESCRIPTION OF EXAMPLE EMBODIMENTS

The following specific example embodiments include video-based image recognition systems. The signals for these image recognition systems are provided by cameras. The image recognition system is designed to recognize various traffic objects, for example vehicles, pedestrians, traffic signs, etc., in the signals, depending on the setup. Other recognition systems are based on radar sensors or ultrasonic sensors, which output signals corresponding to a traffic situation by appropriately scanning the surroundings.

An example recognition system for traffic objects is based on pattern recognition. One or multiple classifiers is/are provided for each traffic object. These classifiers are compared to the incoming signals. If the signals match the classifiers, or if the signals meet the conditions of the classifiers, the corresponding traffic object is considered to be recognized. The specific embodiments described below concern in particular the ascertainment of suitable classifiers.

FIG. 1 shows a first approach for training or establishing classifiers for a pattern recognition. One or multiple cameras 1 generate/s a video data stream. First, a so-called random training sample 2 is generated. This random training sample contains individual image data 10. The appropriate corresponding significance information (“ground truth”) 3 for the image data is generated. The corresponding significance information may contain an indication of whether the image data represent a traffic object, optionally what kind of traffic object, at what relative position, at what relative speed, etc. Corresponding significance information 3 may be manually edited by an operator 7.

The corresponding significance information may also be generated automatically.

Image data 10 and corresponding significance information 3 of random training sample 2 are, for example, repeatedly sent to a training module 4 of the pattern recognition unit. Training module 4 adapts the classifiers of the pattern recognition unit until a sufficient match is achieved between corresponding significance information 3, i.e., traffic objects contained in the image data, and the traffic objects recognized by the pattern recognition unit.

A test sample 5 is generated in addition to random training sample 2. The test sample may be generated in the same way as random training sample 2. Test sample 5 together with image data 11 contained therein and corresponding significance information 6 are used to test the quality of the previously trained classifier. The individual samples of test sample 5 are sent to previously trained classifier 40, and the recognition rate of the traffic objects is statistically evaluated. In this process, an evaluation unit 9 ascertains the recognition rates and the error rates of classifier 40.

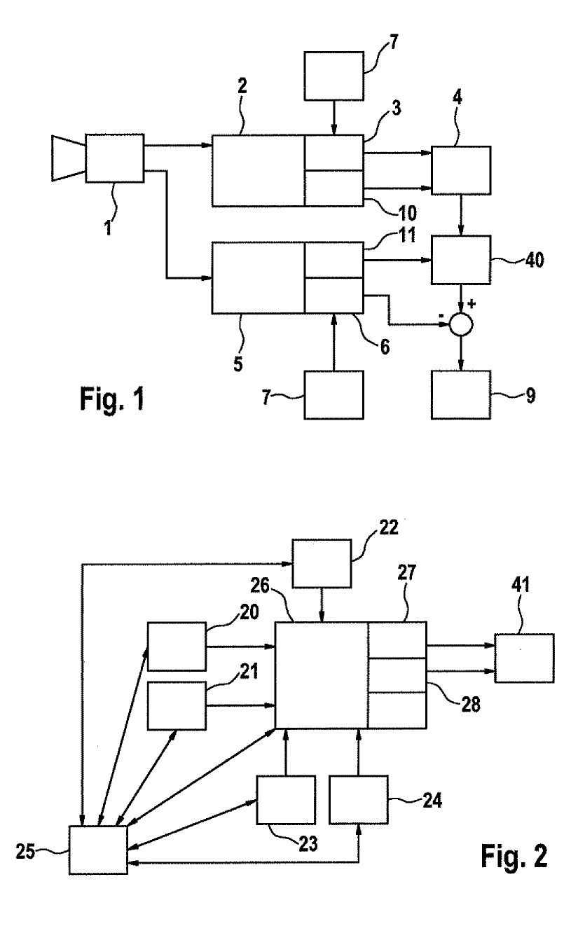

FIG. 2 shows one specific embodiment for training classifiers, in which the significance information is generated. A scene generator 26 generates three-dimensional simulations of various traffic situations. A central control unit 25 is able to check what scenes should be simulated by scene generator 26. For this purpose, control unit 25 may be instructed via a protocol concerning what significance information 28, i.e., what traffic objects, are to be contained in the simulated traffic situations.

For the simulation, central control unit 25 is able to select among various modules 20 through 24 which are connected to scene generator 26. Each module 20 through 24 contains an appearance-related and physics-related description of traffic objects, other objects, weather conditions, light conditions, and optionally also the sensors used. In one embodiment, a motion of the motor vehicle or of the recording sensor may also be taken into account using a motion model 22.

The simulated traffic situation is projected. In one embodiment, the projection may be made onto a screen or other type of projection surface. The camera or another sensor detects the projected simulation of the traffic situation. The signals of the sensor may be sent to a random training sample 27 or optionally to a test sample. Corresponding significance information 28, i.e., the represented traffic objects to be recognized, is known from the simulation. Central control unit 25 or scene generator 26 stores corresponding significance information 28 simultaneously with the detected image data of random training sample 27.

In another embodiment, the sensor is likewise simulated by a module. Here, the module generates the signals which would correspond to signals that the actual sensor would detect in the traffic situation corresponding to the simulation. The projection or imaging of the three-dimensional simulation may thus be carried out within the scope of the simulation. The further processing of the generated signals as a random training sample and of associated significance information 28 is carried out as described above.

Random training sample 27 and the associated significance information are sent to a training module 4 for training a classifier.

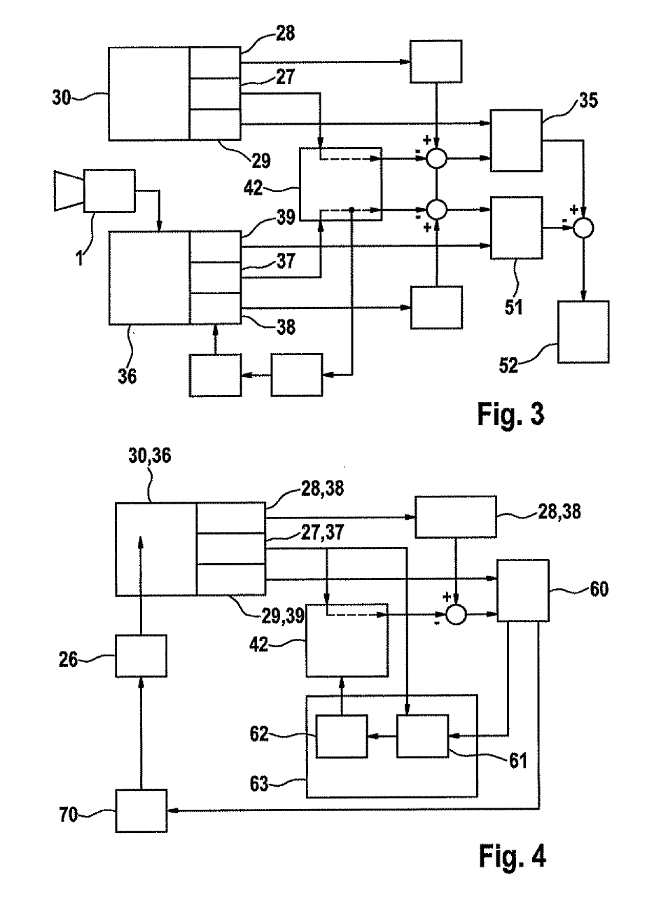

FIG. 3 shows another specific embodiment for testing and/or training a classifier. A scene simulator 30 generates a random training sample 27 together with associated corresponding significance information 28. The random training sample is synthetically generated as described in the preceding specific embodiment in conjunction with FIG. 2. A random training sample 27 is provided based on actual image data. A video data stream, for example, may be recorded using a camera 1. A processing unit, typically with assistance from an operator, ascertains corresponding significance information 38. A classifier is trained with the aid of a training module 42, synthetic random training sample 27, and actual random training sample 37. An evaluation unit 35 is able to analyze the recognition rate of the classifier with regard to specific simulated traffic situations. To enable this process, scene generator 30 stores simulation parameters 29 in addition to simulated signals for random training sample 27 and associated significance information 28. Simulation parameters 29 include in particular the modules used and their settings.

The recognition rate of the classifier may be similarly evaluated for the actual image data. For this purpose, for the detected image data, not only the associated significance information, but also additional information 39 pertaining to the image data is determined and stored. This additional information may concern the general traffic situation, the position of the traffic object to be recognized relative to the sensor, the weather conditions, light conditions, etc.

The recognition rates of the synthetic random training sample and of the actual random training sample may be compared to one another using a further evaluation unit 52. This allows conclusions to be made concerning not only the quality of the trained classifier, but also the quality of the three-dimensional simulations of traffic situations. In this regard FIG. 4 schematically illustrates the manner in which scene generator 26 may be automatically adjusted.

Synthetically generated patterns 27, 30 and actual patterns 36, 37 of the samples are sent to classifier 42. Classifier 42 classifies the patterns. The result from the classification is compared to the ground truth information, i.e., significance information 28, 38. Deviations are determined in comparison module 60. For improving the classifier performance, the system has a learning component 63 which allows classifier 62 to be retrained with the aid of synthetic or actual training patterns 61.

Training patterns 61 may be selected from the patterns for which comparison module 60 has determined deviations, using classifier 42, between the significance information and the classification. Training pattern 61 may also contain other patterns which, although they have not resulted in faulty recognition, may still be improved.

The recognized deviations may also be used to improve synthesis 26 and input modules 20-24 associated therewith.

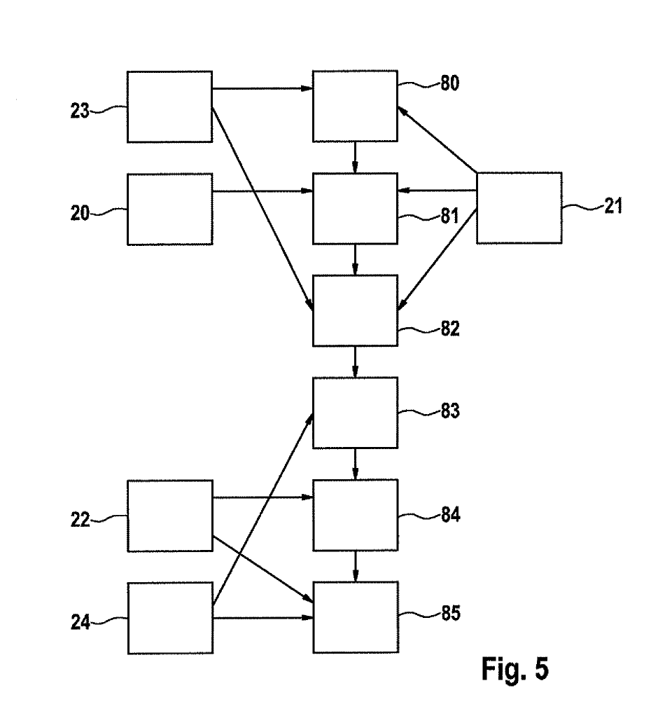

One exemplary embodiment of a process sequence for training a video-based classifier is described with reference to FIG. 5. A traffic object 20, a traffic sign, for example, is represented with regard to its physical dimensions and physical appearance, using an object model 20. A scene model 21 predefines the relative position and motion of the traffic object with respect to the imaginary sensor. The scene model may also include other objects such as trees, houses, roadways, etc. Illumination model 23 and the scene model predefine illumination 80. The illumination has an influence on synthesized object 81, which is also controlled by object model 20 and scene model 21. The realistically illuminated object passes through visual channel 82 predefined by the illumination model and the scene model. After passing visual disturbances 83 which may be predefined by camera model 24, exposure 84 and camera imaging 85 take place. The motion model of camera 22 controls the exposure and the imaging in camera 85, which is generally established by camera model 24. Camera imaging 85 or projection is subsequently used as a sample for training the classifiers.

The test of the classifier may be carried out as described on synthetic and actual signals. A test of actual data as described in conjunction with FIG. 3 may evaluate the quality of the synthetic training for an actual situation. An object model 20 for a traffic object may be designed in such a way that the object model ideally describes the traffic object. However, it is preferable to also provide for the integration of minor perturbations into object model 20. An object model may contain, among other things, a geometric description of the object. For flat objects such as traffic signs, for example, a graphical definition of the sign in an appropriate shape may be selected. For large-volume objects, for example a vehicle or pedestrian, the object model preferably contains a three-dimensional description. With regard to the object geometry, the referenced minor perturbations may contain a deformation of the object, concealment by other objects, or a lack of individual parts of the object. Such a missing object may be a missing bumper, for example. The surface characteristics of the object may also be described in the object model. These characteristics include the surface pattern, color, symbols, etc. In addition, texture characteristics of the objects may be integrated into the object model. Furthermore, the object model advantageously includes a reflection model of incident light beams, a possible self-illuminating characteristic (for traffic lights, blinking lights, roadway lights, etc.). Dirt, snow, scratches, holes, or graphic changes on the surface may also be described by the object model.

The position of the object in space may likewise be integrated into the object model, or alternatively the position of the object may be described in scene model 21 described below. The position includes on the one hand a static position, an orientation in space, and the relative position. On the other hand, the motion of the object in space as well as its translation and rotation may also be described.

The scene model may include, for example, a roadway model such as the course of the roadway and the lanes in the roadway, a weather model or weather condition model containing information concerning dry weather, a rain model including misting rain, light rain, heavy rain, pouring rain, etc., a snow model, a hail model, a fog model, and a visibility simulation; a landscape model having surfaces and terrain models, a vegetation model including trees, foliage, etc., a building model, and a sky model including clouds, direct and indirect light, diffused light, the sun, and daytime and nighttime.

A model of sensor 22 may be moved within the simulated scene. For this purpose, the sensor model may contain a motion model of the measuring sensor. The following parameters may be taken into account: speed, steering wheel angle, steering wheel angular velocity, steering angle, steering angular velocity, pitch angle, pitch rate, yaw rate, yaw angle, roll angle, and roll rate. A realistic dynamic motion model of the vehicle on which the sensor is mounted may likewise be taken into account, for which purpose a model for vehicle pitch, roll, or yaw is provided. It is also possible to model typical driving maneuvers such as cornering, changing lanes, braking and acceleration operations, and traveling in forward and reverse motion.

Illumination model 23 describes the illumination of the scene, including all light sources which are present. This may include the following characteristics, among others: the illumination spectrum of the particular light source, illumination by the sun with clear skies, various sun conditions, diffused light such as for overcast skies, for example, backlighting, illumination from behind (reflected light), and twilight. Also taken into account are the light cones of vehicle headlights for parking lights, low-beam lights, and high-beam lights for the various types of headlights, for example halogen lamp, xenon lamp, sodium vapor lamp, mercury vapor lamp, etc.

A model of sensor 24 includes, for example, a video-based sensor together with image characteristics of the camera, the lens, and the beam path directly in front of the lens. The illumination characteristics of the camera pixels, the characteristic curve thereof when illuminated, and the dynamic response, noise characteristics, and temperature response thereof may be taken into account. Illumination control, the control algorithm, and shutter characteristics may be taken into account. The modeling of the lens may include the spectral characteristics, the focal length, the f-stop number, the calibration, the distortion (pillow distortion, barrel distortion) within the lens, scattered light, etc. In addition, computation characteristics, spectral filter characteristics of a window glass, smears, streaks, drops, water, and other contaminants may be taken into account.

Scene generator 26 combines the data of the various models and generates the synthesized data therefrom. In a first variant, the appearance of the entire three-dimensional simulation may be determined and stored as a sequence of video images. The associated significance information and synthesis parameters are stored. In another variant, only the appearance of the particular traffic object to be recognized is determined and stored. The latter variant may be carried out more quickly, and conserves memory. However, training of the classifier may also be carried out only on the individual traffic object.

1-10. (canceled)

11. A method for setting up a traffic object recognition system, comprising:
simulating, by a scene generator, three-dimensional simulations of various traffic situations which include at least one traffic object;
generating, by a projection unit, signals which correspond to signals that a sensor detects in a traffic situation simulated by the three-dimensional simulation;
sending signals for recognizing traffic objects to a pattern recognition unit; and
training the pattern recognition unit based on a deviation between the traffic objects simulated in the traffic situations and the recognized traffic objects.

12. The method as recited in claim 11, further comprising:
training the traffic object recognition system using actual traffic situations.

13. The method as recited in claim 11, further comprising:
adapting at least one of the scene generator and the projection unit based on a deviation between the traffic objects simulated in traffic situations and the recognized traffic objects.

14. The method as recited in claim 11, wherein the projection unit physically projects the simulated traffic situation, and, for generating the signals, the sensor detects the physically projected traffic situation.

15. The method as recited in claim 11, wherein the simulation of the traffic situation includes at least one of a roadway model, a weather model, a landscape model, and a sky model.

16. The method as recited in claim 11, wherein the simulation of the traffic situation includes at least one of an illumination model, and a light beam tracking model.

17. The method as recited in claim 11, wherein the simulation of the traffic situation includes a motion model of a vehicle using the sensor.

18. The method as recited in claim 11, wherein data of recorded actual traffic situations and information concerning the traffic objects present in the recorded actual traffic situation are also provided, and the pattern recognition unit is trained based on a deviation between the traffic objects present in the recorded actual traffic situations and the traffic objects recognized by the pattern recognition unit.

19. A traffic object recognition system for recognizing a traffic object in a traffic situation, comprising:
at least one sensor to detect a traffic situation; and
a pattern recognition unit to recognize the traffic object in the detected traffic situation;
wherein the pattern recognition unit is configured so that it is trained based on three-dimensional virtual traffic situations which contain the traffic object.

20. A method for recognizing a traffic object in a traffic situation, comprising:
detecting a traffic situation using at least one sensor; and
recognizing the traffic object in the detected traffic situation using a pattern recognition unit which is trained based on three-dimensional virtual traffic situations which contain the traffic object.
